(19) United States
(12) Patent Application Publication
(10) Pub. No.: US 2020/0253809 A1
(43) Pub. Date: Aug. 13, 2020

(54) MODULAR HARNESS FOR PATIENTS WITH POST-NEUROLOGIC INJURY

(71) Applicant: University of Louisville Research Foundation, Inc., Louisville, KY (US)

(72) Inventors: Andrea L. Behrman, Louisville, KY (US); Thomas Roussel, Louisville, KY (US)

(21) Appl. No.: 16/789,572

(22) Filed: Feb. 13, 2020

Related U.S. Application Data
(60) Provisional application No. 62/804,985, filed on Feb. 13, 2019.

(51) Int. Cl. A61H 3/00

(52) U.S. Cl. CPC A61H 3/008; A61H 2201/163; A61H 2201/1652; A61H 2203/0406; A61H 2201/1642; A61H 2201/1685; A61H 2201/1635

(57) ABSTRACT

A harness used for a locomotor training of a patient, such as a pediatric patient, is provided. The harness has a bottom strap, such as two leg straps, for providing pelvic support to the patient and a pelvic band for providing waist support to the patient. The bottom strap is releasably connected to the pelvic band. Multiple lifting straps are connected to the pelvic band. The lifting straps can be manipulated to provide partial weight support to the patient. The harness has circumferential bands of varying widths that can be easily added and removed to provide maximum trunk support to minimal or no trunk support across the length of the trunk. This allows the harness to dynamically meet the needs of trunk support as the patient advances.

### CROSS-REFERENCE TO RELATED APPLICATIONS

This application claims priority to U.S. Provisional Application 62/804,985 filed Feb. 13, 2019. The complete contents thereof are herein incorporated by reference.

### FIELD

The present disclosure and the embodiments thereof are in the field of harnesses for providing support to a patient. More particularly, the present disclosure relates to a modular harness used in a locomotor training process for patients with post-neurologic injury.

### BACKGROUND

Locomotor training is a therapeutic intervention promoting neuromuscular recovery after spinal cord injury (SCI) and other neurological disorders. The therapy was developed from knowledge and understanding of walking and activity-dependent neuroplasticity of the central nervous system, in particular, the spinal cord. For patients with SCI, the aim of the therapy is to activate the neuromuscular recovery below and across the level of the lesion through intense practice and repetition of the task of walking and standing. Known benefits of locomotor training for adults with SCI include improved standing, walking, balance, endurance, and walking speed. Other physiological benefits have been reported and have improved the quality of life for adults. To conduct a locomotor training, the retraining of the neuromuscular system occurs during training on a treadmill with the patient wearing a harness and provided with partial body weight support (BWS) to an overhead support system. Computer-controlled equipment can be used to monitor, control and record the patients' body weight support throughout training, while manual trainers promote a task-specific sensorimotor experience.

However, the therapeutic intervention program has not been extended to the pediatric population with SCI. For example, the current treadmill system, which is integrated with a BWS system and a harness for adults, is designed for use with patients weighting over 100 lbs, while children aged from 1-12 years mostly weigh 22-80 lbs. The adult system is neither suitable for the pediatric population nor suitable for the physical therapist and trainers providing therapy to the pediatric population.

Accordingly, there exists a need for providing a recovery system that suits the needs of the pediatric population, while still being usable by adults, and the physical therapists or trainers providing therapy.

### SUMMARY

In one aspect of the present disclosure, a harness used for a locomotor training of a patient is provided. The harness provides support during standing and stepping activities on or off the treadmill in the clinic or in the home setting. The harness includes a pelvic band in order to best “purchase” the harness to the patient, a bottom strap which may comprise two adjustable straps attached to the pelvic band, anterior and posterior, that serve to maintain the pelvic band in place. The strap lengths may be adjusted anteriorly, and the straps move across the buttocks, lying flat on the inner thigh, and attach at the anterior pelvis. The bottom strap, e.g. two leg straps, are releasably connected to the pelvic band. The pelvic band is adjustable via anterior and posterior adjustments. The harness further includes a plurality of lifting straps connected to the pelvic band. The lifting straps are manipulatable to provide partial weight support to the patient.

In some embodiments, the harness further comprises a plurality of handles provided to the pelvic band, for allowing a trainer of the locomotor training to guide the hips of the patient during the therapeutic activity of ‘locomotor training’. In some embodiments, the bottom strap comprises at least one bottom strap having a front end and a rear end, the rear end fixed to the pelvic band and the front end releasably connected to the pelvic band through a buckle, and wherein the front end of the bottom strap is adjustable to tighten the bottom strap. In some embodiments, the bottom strap further comprises a soft padding releasably wrapped around the at least one bottom strap.

In further embodiments, the pelvic band comprises a first end and a second end connected to each other through a middle buckle, wherein the distance between the first end and the second end of the pelvic band is adjustable to tighten the pelvic band.

In further embodiments, the harness comprises an upper body support system for guiding the upper torso of the patient during the locomotor training. In some embodiments, the upper body support system comprises an adjustable upper trunk support above the pelvic band, for maintaining the upper trunk the patient in a correct posture during the locomotor training. In some embodiments, the harness further comprises a plurality of strap holders connected to the adjustable upper trunk support, wherein a respective lifting strap passes through a respective strap holder. In some embodiments, the upper body support system comprises an adjustable shoulder strap for maintaining the shoulders of the patient in a correct posture during the locomotor training; an adjustable upper trunk support below the shoulder strap, for maintaining the upper trunk the patient in a correct posture during the locomotor training; and a front piece below the adjustable upper trunk support and between two front lifting straps.

In further embodiments, the pelvic band is in the form of a belt and the length of the pelvic band is adjustable laterally. In some embodiments, the harness further comprises a plurality of strap holders connected to the pelvic band, wherein a respective lifting strap passes through a respective strap holder and the bottom strap. In some embodiments, the bottom strap and the pelvic band are formed as one piece.

Another aspect of the present disclosure, provides methods of using a harness as described herein, e.g. for locomotor training.

### BRIEF DESCRIPTION OF THE DRAWINGS

FIG. 1 is a perspective view of a harness according to an embodiment of the present disclosure;

FIG. 2 is a schematic view showing the harness of FIG. 1 in use;

FIG. 3 is a diagram of exemplary dimensions of a harness according to some embodiments of the disclosure;

FIG. 4 is a perspective view of a harness according to another embodiment of the present disclosure;

FIG. 5 is a perspective view of a harness according to still another embodiment of the present disclosure;

FIG. 6 is a perspective view of a harness according to yet another embodiment of the present disclosure;

FIG. 7 is a perspective view of a harness according to yet another embodiment of the present disclosure;

FIG. 8 is a perspective view of a harness according to yet another embodiment of the present disclosure;

FIG. 9 is a perspective view of a harness according to yet another embodiment of the present disclosure.

FIG. 10A-B are a (A) front and (B) back view of a harness according to some embodiments of the disclosure.

FIG. 11A-B are a (A) front and (B) back view of an adjustable upper truck support or torso band/strap according to some embodiments of the disclosure.

### DETAILED DESCRIPTION OF EMBODIMENTS

The present disclosure will now be described in greater detail by referring to the following discussion and drawings that accompany the present disclosure. It is noted that the drawings of the present disclosure are provided for illustrative purposes only and, as such, the drawings are not drawn to scale. It is also noted that like and corresponding elements are referred to by like reference numerals.

In the following description, numerous specific details are set forth, such as particular structures, components, materials, dimensions, processing steps and techniques, in order to provide an understanding of the various embodiments of the present disclosure. However, it will be appreciated by one of ordinary skill in the art that the various embodiments of the present disclosure may be practiced without these specific details. In other instances, well-known structures or processing steps have not been described in detail in order to avoid obscuring the present disclosure.

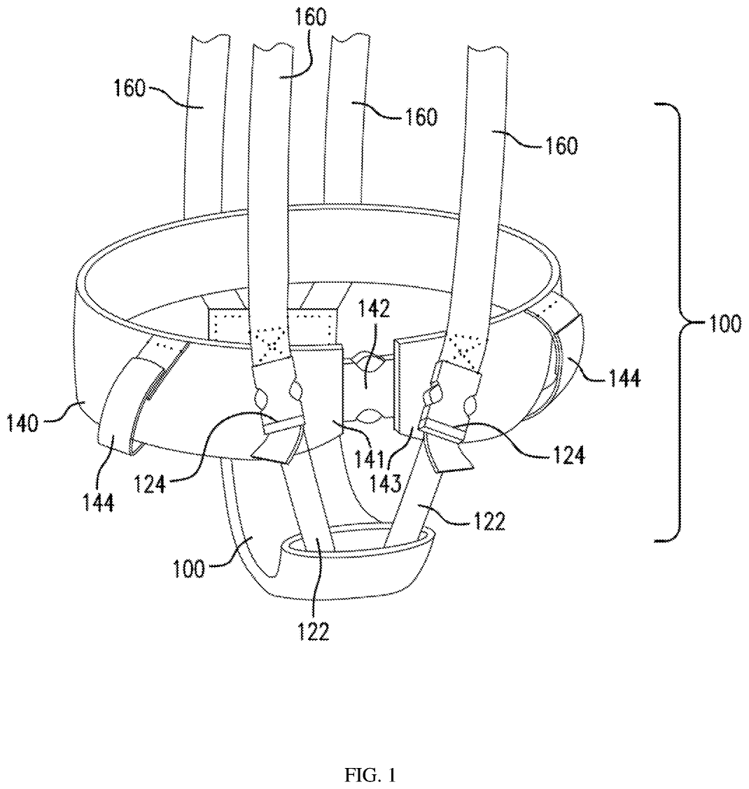

FIG. 1 shows a perspective view of a harness 100 according to an exemplary embodiment of the present disclosure. In general, the harness 100 includes a bottom strap 120 providing pelvic support to a patient, a pelvic band 140 providing pelvic placement of the harness on the patient and securing it, and a plurality of lifting straps 160, all of which are designed as modular components and can be selectively separated from and attached to each other.

The bottom strap 120 can include an external soft padding and an internal core surrounded by the soft padding. The external soft padding provides comfort and protection to a patient, while the internal core secures the pelvic band and maintains its purchase on the patient. While certain conventional harnesses for supporting weight are designed to support a patient when the patient (or user) is in a seated position, the bottom strap 120 of the harness 100 allows for comfortable support to the patient when the patient is in a standing position and thus, allows the patient to step. The bottom strap 120 is designed as a modular element. As a result, the bottom strap can be removed and reattached to the other components of the harness, which allows the bottom strap 120 to be cleaned and sterilized to promote good hygiene and also allows multiple pads of different sizes to be retrofitable to the harness to accommodate the needs of different patients.

For example, a pair of bottom straps 122, which extends through the bottom strap 120, can be provided for allowing the bottom strap 120 to slide with respect to the bottom straps 122 to be removed from and reattached to the harness 100. The rear ends of the bottom straps 122 can be fixed to the pelvic band 140 and the front ends of the bottom straps 122 can be releasably connected to the pelvic band 140 through a fastening element such as a pair of buckles 124, respectively, which allows a therapist or trainer to fasten the harness 100 on the patient while the patient lays down. The buckles 124 are provided on the outside of the pelvic band 140 for comfort and to allow better movement of the legs of the patient. In addition, the position of the front ends of the bottom straps 122 can be adjusted to tighten the inseam drop distance for a secure and comfortable fit. Alternative fastening elements that are compatible with the disclosure, include but are not limited to, hook-and-loop (e.g. Velcro®), snaps, and buttons.

The pelvic band 140 has a first end 141, a second end 143 and a middle fastening element, such as a buckle 142 for releasably connecting the first end 141 and the second end 143. The distance between the first end 141 and the second end 143 can be adjusted by manipulating the position of the first end 141 and/or the position of the second end 143 with respect to the middle buckle 142. The pelvic band 140 allows the therapist or trainer to fasten the harness 100 on the patient while the patient lays down, which eliminates the need for the patient to be able to sit or stand while putting on the harness. The harness though can also be applied in the standing position.

A plurality of handles 144 are provided along the pelvic band 140 for allowing the therapist or trainer to guide the hips of the patient during standing or stepping activities 100. The handles 144 are ergonomic and suitable for releasing the strain on the therapist or trainer's hands and wrists. The handles 144 can be made of any suitable material, such as a plastic material. The handles 144 may also include a foam padding for comfort. There may be an inner and outer handle allowing for variability in the trainer's hand and wrist sizes and greater comfort and fit afforded.

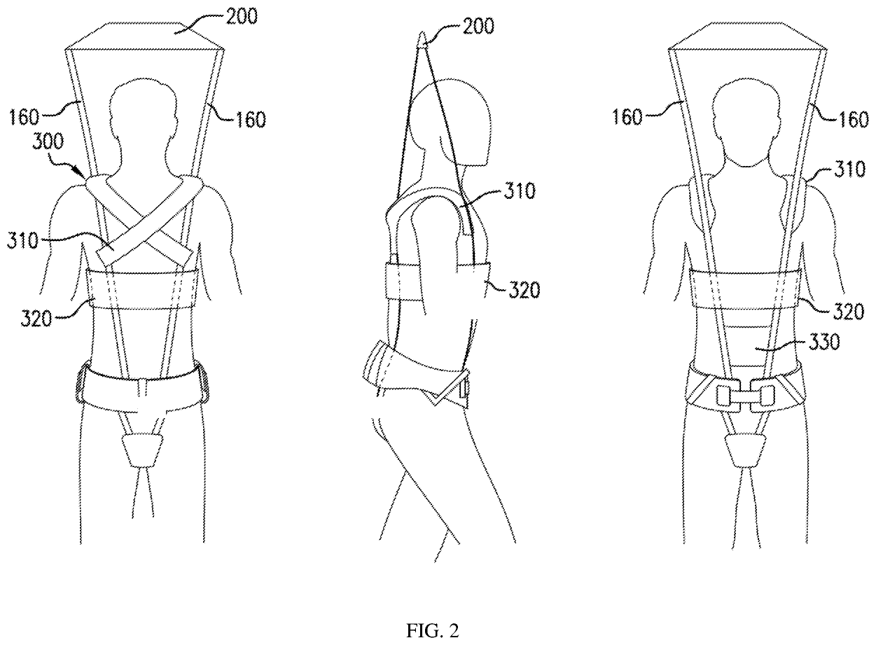

The plurality of lifting straps 160 are connected to the pelvic band 140 in a fixed or releasable manner. In the shown embodiment, the lifting straps 160 include two front straps and two rear straps. A front strap can be connected to a respective rear strap through a fastening element such as a buckle or carabiner. As shown in FIG. 2, the lifting straps 160 can engage a supporting structure 200 of an overhead support system (not shown), e.g. as used with a treadmill or reverse walker, to provide partial weight support to the patient wearing the harness 100. The lifting straps 160 are guided away from ears of the patient and can be provided with paddings where the straps 160 touch the torso of the patient. The lifting straps 160 can be made of suitable materials. In use, after the lifting straps 160 and the supporting structure 200 properly engage each other to provide partial weight support for the patient, the patient can start a locomotor training with the assistance and guidance of the therapist or trainer. The straps may be attached to any over head body weight support apparatus whether over ground or over a treadmill.

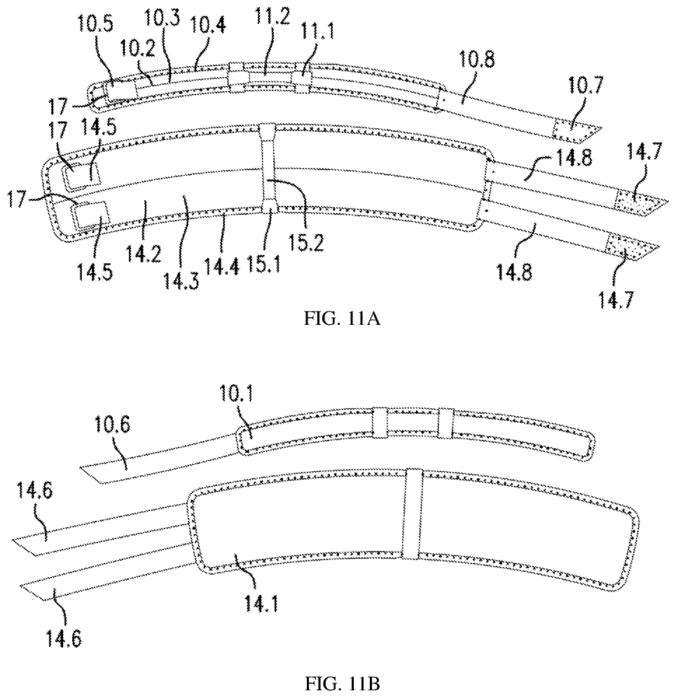

As shown in FIG. 2, optionally, the harness 100 can further include an upper body support system 300. The upper body support system 300 is fully adjustable and customizable, which allows for more or less support based on the patient's needs and abilities. The upper body support system 300 may include at least one adjustable shoulder strap 310, which can be used to hold back the shoulders of the patient or to maintain the shoulders in a correct posture, during a locomotor training. The upper body support system 300 can also include an adjustable upper trunk support 320 provided below the shoulder strap 310 if present, and a front piece 330 provided below the upper trunk support 320 and between the two front lifting straps 160. In some embodiments, the upper body support system 300 includes only the adjustable upper trunk support 320, also called a torso band or strap. The upper trunk support 320 may comprise one or more circumferential straps that weave through the lifting straps to provide ‘trunk support’ to varying degrees, and of various widths, e.g. by adjusting laterally like a belt. As shown in FIG. 11, the torso band may be provided in various sizes depending on the size and needs of the patient. The upper trunk support 320 can provide support to the patient and facilitate guiding the torso of the patient in a correct position, during a locomotor training including standing and stepping activities on and off the treadmill. The shapes and dimensions of the components of the upper body support system 300 can be customized to accommodate the needs of patients. The upper body support system 300 allows the trainer to better measure patient's progress on trunk control and also allows the trainer to change the support type mid-session for different exercises quickly and safely. As a patient's trunk control progresses, circumferential straps are easily removed or sized differently (width) to allow less support as a patient's trunk control progresses, improves, or advances. From this vantage, the harness can adapt to a patient's needs and allows for progress via any therapeutic strategy.

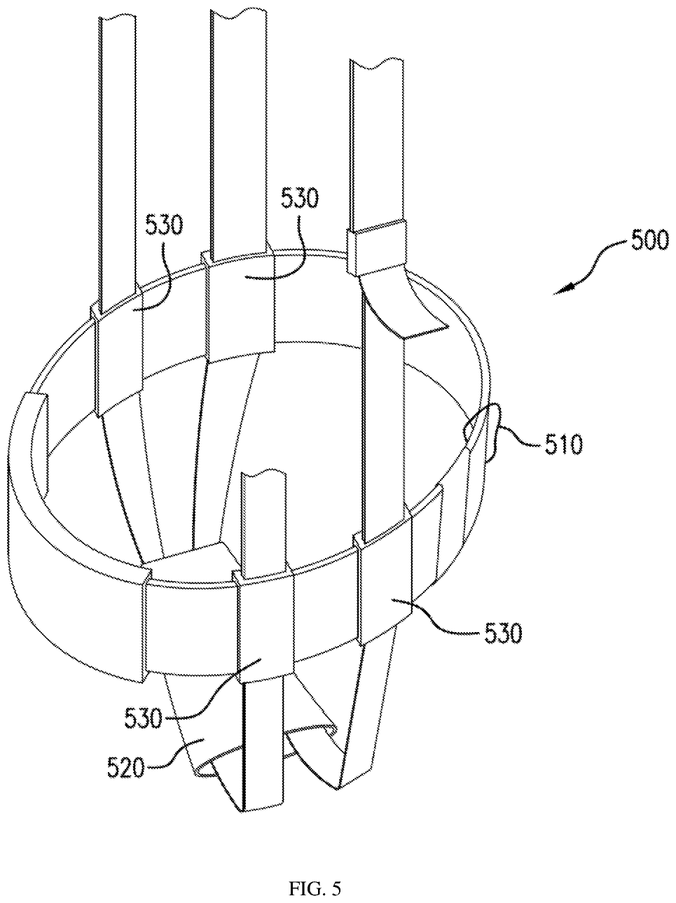

FIG. 4 shows a harness 400 according to another embodiment of the present disclosure. The harness 400 includes a bottom strap 420 and a pelvic band 410, which are formed as one piece. The bottom strap 420 has a pair of leg straps, which can be connected to the pelvic band 410 through a fastening element such as buckles. The adjustment of the bottom strap 410 and the pelvic band 420 can be implemented by adjusting the position of the free ends of the straps 412 with respect to the buckles. The harness 400 further includes a plurality of lifting straps 430, which are similar to the lifting straps 160 of the harness 100.

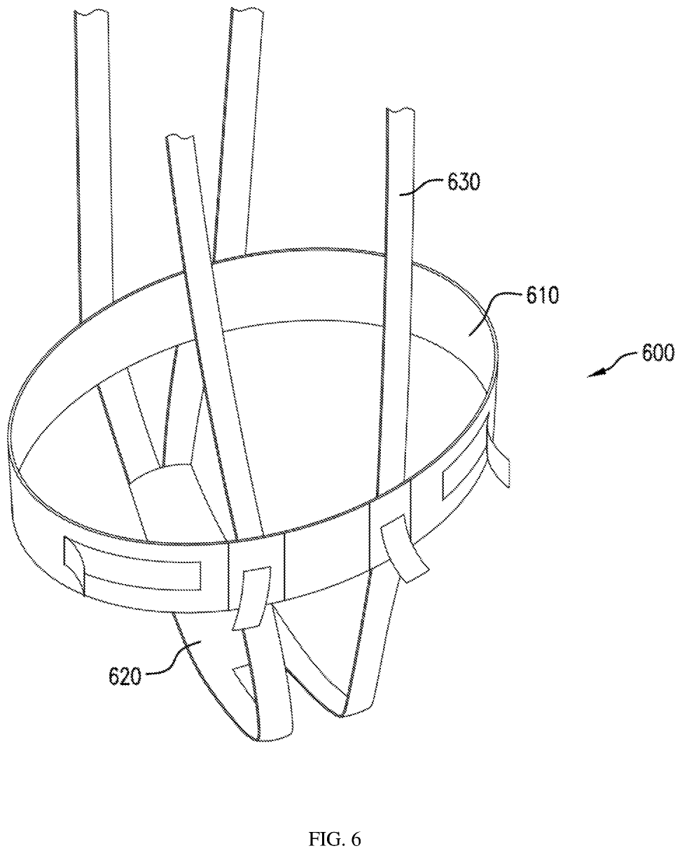

FIG. 5 shows a harness 500 according to still another embodiment of the present disclosure. The harness 500 includes an adjustable pelvic band 510, which is in the shape of a wide belt conformed to the pelvis and the length of which can be adjusted laterally like a belt. The harness 500 further includes a bottom strap 520. A plurality of strap holders 530 are fixedly provided to the pelvic band 510. Each strap holder 530 defines a passageway, through which a respective lifting strap passes. The lifting strap also passes through the bottom strap 520 to provide a simplified harness.

FIG. 6 shows a harness 600 according to yet another embodiment of the present disclosure. The harness 600 includes an adjustable pelvic band 610, which is in the shape of a belt and the length of which can be adjusted laterally like a belt. The harness 600 further includes a bottom strap 620 and a plurality of lifting straps 630, which are similar to that of the harness 100.

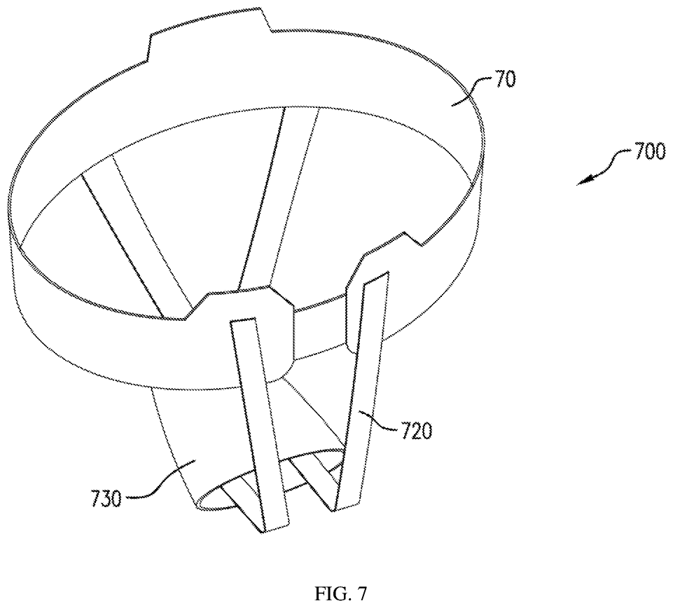

FIG. 7 shows a harness 700 according to yet another embodiment of the present disclosure. The harness 700 includes an adjustable pelvic band 710, which is in the shape of a belt and the length of which can be adjusted laterally like a belt. The harness 700 further includes a pair of bottom straps 720. The rear ends of the bottom straps 720 are connected to a rear surface of the pelvic band 710. The front ends of the bottom straps 720 are releasably connected to a front surface of the pelvic band 710, for example, through Velcro. The harness 700 further includes a bottom strap 730, which can be folded over the bottom straps 720 in a releasable manner.

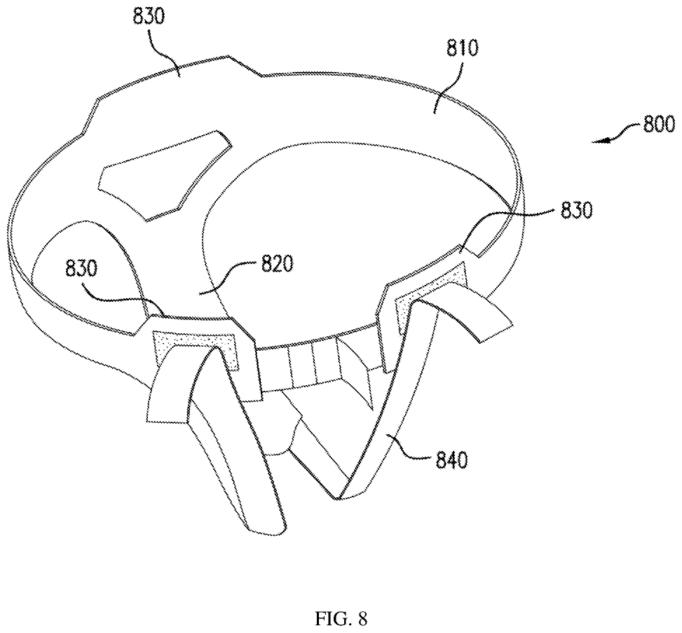

FIG. 8 shows a harness 800 according to yet another embodiment of the present disclosure. The harness 800 includes an adjustable pelvic band 810, which is provided with a plurality of handles 830. The harness 800 further includes a bottom strap 820, and a pair of adjustable bottom straps 840 that can be manually tightened.

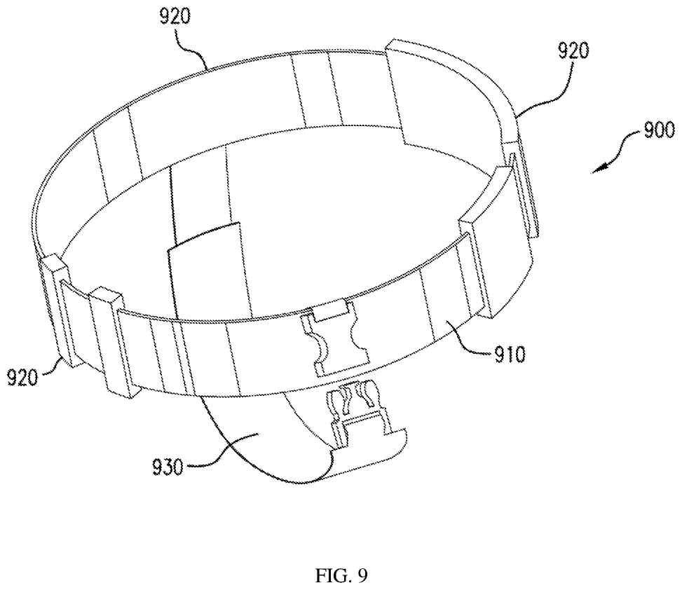

FIG. 9 shows a harness 900 according to yet another embodiment of the present disclosure. The harness 900 includes an adjustable pelvic band 910, which is in the shape of a belt and the length of which can be adjusted laterally, and a plurality of handles 920 connected to the pelvic band 910. The harness 900 further includes a bottom strap 930 that can be buckled to the pelvic band 910. This embodiment is suitable for a pediatric population of 1-4 years old.

Different colors can be applied to the harnesses as described above to promote individuality and good morale. Furthermore, the harnesses can be color coded to be representative of different ages of the patients.

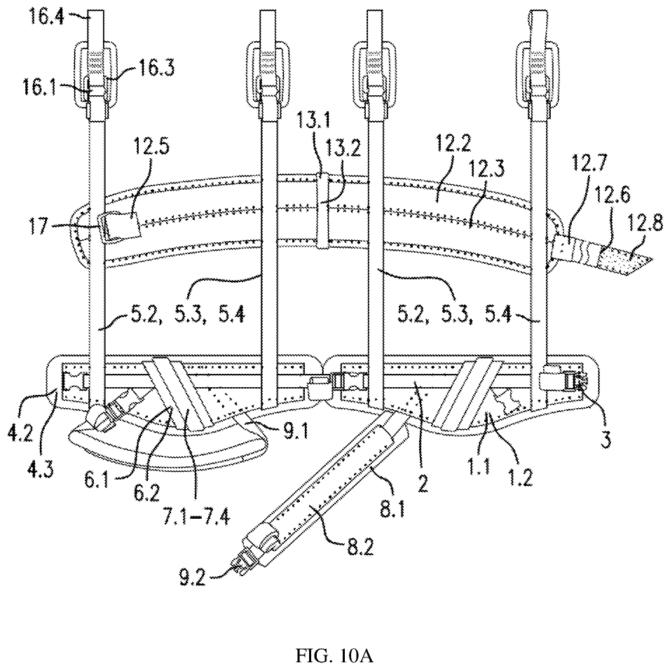

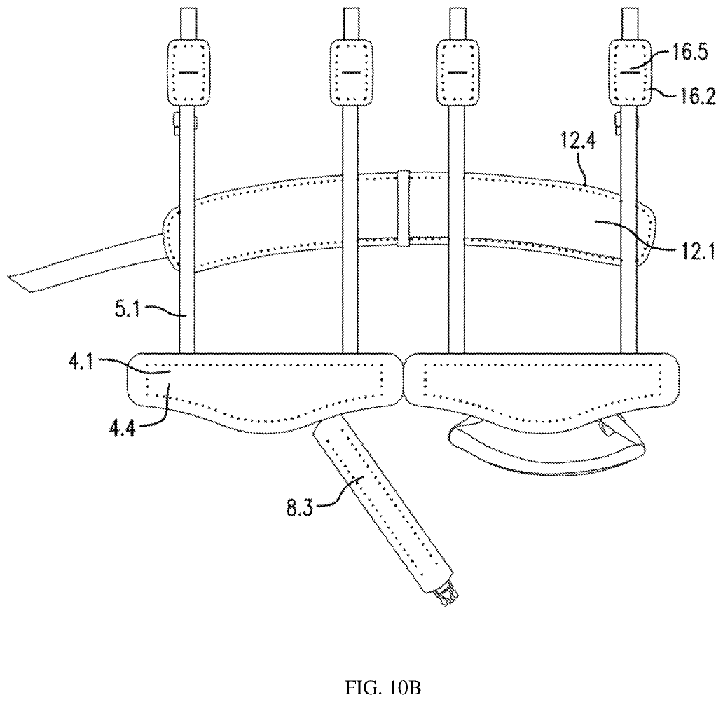

Tables 1 and 2 provide exemplary materials and associated dimensions that may be used in a harness according to some embodiments of the disclosure with reference to the reference numerals used in FIGS. 10-11. All exemplary materials may be substituted with suitable alternative materials, e.g. other nonwoven fabrics or plastics known in the art. All exemplary dimensions may be adjusted based on the intended subject, e.g. children or adults.

TABLE 1

| Component # | Component Description | Material | Color | Quantity |
|---|---|---|---|---|
| 1.1 | Pelvic Plate | HDPE plastic | | 2 |
| 1.2 | Plate Covering | Ripstop | Color | 2 |
| 2 | Pelvic Webbing | ¾″ ltwt | Black | 2 |
| 3 | Pelvic Buckle | ¾″ side squeeze | Black | 2 |
| 4.1 | Pelvic Foam Bottom | EV50 | | 2 |
| 4.2 | Pelvic Foam Top | LD 60 | | 2 |
| 4.3 | Pelvic Outer Fabric | Cordura | Color | 2 |
| 4.4 | Pelvic Inner Fabric | Superfabric#700670 | Black | 2 |
| 5.1 | Suspenders | ¾″ ltwt | Black | 4 |
| 5.2 | Suspenders Flaps | ¾″ ltwt | Black | 4 |
| 5.3 | Flap Velcro Hook | ¾″ | Black | 4 |
| 5.4 | Suspender Velcro Loop | ¾″ | Black | 4 |
| 6.1 | Elastic Handle | 2″ Elastic | Black | 4 |
| 6.2 | Elastic Handle Velcro | 2″ Hook/Loop | Black | 4 |
| 7.1 | Rigid Handle Outer | 1″ Tubular | Black | 2 |
| 7.2 | Rigid Handle Inner Tube | Plastic Tubing | Black | 4 |
| 7.3 | Inner Tube Support | 3 mm Cord | Black | 4 |
| 7.4 | Rigid Handle Foam | LD 60 | | 2 |
| 8.1 | Leg Loop Webbing Cover | 1″ ltwt | Black | 2 |
| 9.1 | Leg Loop Webbing | ¾″ ltwt | Black | 2 |
| 8.2 | Leg Loop Foam | EV50 x2 | | 4 |
| 8.3 | Leg Loop Fabric | Pattern Polyester | Color | 2 |
| 9.2 | Leg Loop Buckles | ¾″ side squeeze | Black | 2 |
| 10.1 | 2″ Torso Band Foam | 3/16″ Laminate | Black | 2 |
| 10.2 | 2″ Torso Band Plate | HDPE plastic | | 1 |
| 10.3 | 2″ Torso Band Loop | 2″ Loop | Black | 1 |
| 10.4 | 2″ Torso Band Edge | Heringbone | Black | 1 |

TABLE 2

| Component | Component Description | Material | Color | Quantity |
|---|---|---|---|---|
| 10.5 | 2″ Torso Band Buckle Holder | 1½″ lwt | Black | 1 |
| 10.6 | 2″ Torso Band Strap | 1½″ lwt | Black | 1 |
| 10.7 | 2″ Torso Band Strap Hook | 1½″ Hook | Black | 1 |
| 10.8 | 2″ Torso Band Strap Loop | 1½″ Loop | Black | 1 |
| 11.1 | 2″ Torso Band Strap Handle | 1″ Flat | Black | 1 |
| 11.2 | 2″ Torso Band Strap Handle | 3″ ltwt | Black | 1 |
| 12.1 | 4″ Torso Band Foam | 3/16″ Laminate | Black | 1 |
| 12.2 | 4″ Torso Band Plate | HDPE plastic | | 1 |
| 12.3 | 4″ Torso Band Loop Velcro | 2″ Loop | Black | 1 |
| 12.4 | 4″ Torso Band Edge Tape | Heringbone | Black | 1 |
| 12.5 | 4″ Torso Band Buckle Holder | 1½″ lwt | Black | 1 |
| 12.6 | 4″ Torso Band Strap | 1½″ lwt | Black | 1 |
| 12.7 | 4″ Torso Band Strap Hook | 1½″ Hook | Black | 1 |
| 12.8 | 4″ Torso Band Strap Loop | 1½″ Loop | Black | 1 |
| 13.1 | 4″ Torso Band Strap Handle | 1″ Flat | Black | 1 |
| 13.2 | 4″ Torso Band Strap Handle | 3″ ltwt | Black | 1 |
| 14.1 | 6″ Torso Band Foam | Laminate | Black | 1 |
| 14.2 | 6″ Torso Band Plate | HDPE plastic | | 1 |
| 14.3 | 6″ Torso Band Logo Velcro | 2″ Loop | Black | 1 |
| 14.5 | 6″ Torso Band Buckle Holders | 1½″ lwt | Black | 2 |
| 14.6 | 6″ Torso Band Straps | 1½″ lwt | Black | 2 |
| 14.7 | 6″ Torso Band Strap Hook | 1½″ Hook | Black | 1 |
| 14.8 | 6″ Torso Band Strap Loop | 1½″ Loop | Black | 1 |
| 15.1 | 6″ Torso Band Strap Handle | 1″ Flat | Black | 1 |
| 15.2 | 6″ Torso Band Strap Handle | 3″ ltwt | Black | 1 |
| 16.1 | Tie In Point Buckle | 1″ Quick Adjust | Black | 4 |
| 16.2 | Tie In Point Foam | 3/16″ Laminate | Black | 4 |
| 16.3 | Tie In Point Fabric | Cordura | Color | 4 |
| 16.4 | Tie In Point Webbing | 1″ ltwt | Black | 4 |
| 16.5 | Tie In Point Edge Tape | Heringbone | Black | 4 |
| 17 | Torso Band Buckles | 1½″ Tri Glide | Black | 4 |

FIG. 10-11 are illustrations of a harness according to some embodiments of the disclosure. The identity of the reference numerals are as follows:

### FIG. 10A

1.1 Pelvic Plate
1.2 Plate Covering
2 Pelvic Webbing
3 Pelvic Buckle
4.2 Pelvic Foam Top
4.3 Pelvic Outer Fabric
5.2 Suspenders Raps
5.3 Rap Velcro Hook
5.4 Suspender Velcro Loop
6.1 Elastic Handle
6.2 Elastic Handle Velcro
7.1 Rigid Handle Outer
7.2 Rigid Handle Inner Tube
7.3 inner Tube Support
7.4 Rigid Handle Foam
8.1 Leg Loop Webbing Cover
8.2 Leg Loop Foam
9.1 Leg Loop Webbing
9.2 Leg Loop Buckles
12.2 4″ Torso Band Plate
12.3 4″ Torso Band Loop Velcro
12.5 4″ Torso Band Buckle Holder
12.6 4″ Torso Band Strap
12.7 4″ Torso Band Strap Hook
12.8 4″ Torso Band Strap Loop
13.1 4″ Torso Band Strap Handle
13.2 4″ Torso Band Strap Handle Wrap
16.1 Tie In Point Buckle
16.3 Tie In Point Fabric
16.4 Tie In Point Webbing
17 Torso Band Buckle

### FIG. 10B

4.1 Pelvic Foam Bottom
4.4 Pelvic inner Fabric
5.1 Suspenders
8.3 Leg Loop Fabric
12.1 4″ Torso Band Foam
12.4 4″ Torso Band Edge Tape
16.2 Tie In Point Foam
16.5 Tie In Point Edge Tape

### FIG. 11A-B

10.1 2″ Torso Band Foam
10.2 2″ Torso Band Plate
10.3 2″ Torso Band Loop Velcro
10.4 2″ Torso Band Edge Tape
10.5 2″ Torso Band Buckle Holder
10.6 2″ Torso Band Strap
10.7 2″ Torso Band Strap Hook
10.8 2″ Torso Band Strap Loop
11.1 2″ Torso Band Strap Handle
11.2 2″ Torso Band Strap Handle Wrap
14.1 6″ Torso Band Foam
14.2 6″ Torso Band Plate
14.3 6″ Torso Band Loop Velcro
14.4 6″ Torso Band Edge Tape
14.5 6″ Torso Band Buckle Holders
14.6 6″ Torso Band Straps
14.7 6″ Torso Band Strap Hook
14.8 6″ Torso Band Strap Loop
15.1 6″ Torso Band Strap Handle
15.2 6″ Torso Band Strap Handle Wrap
17 Torso Band Buckles

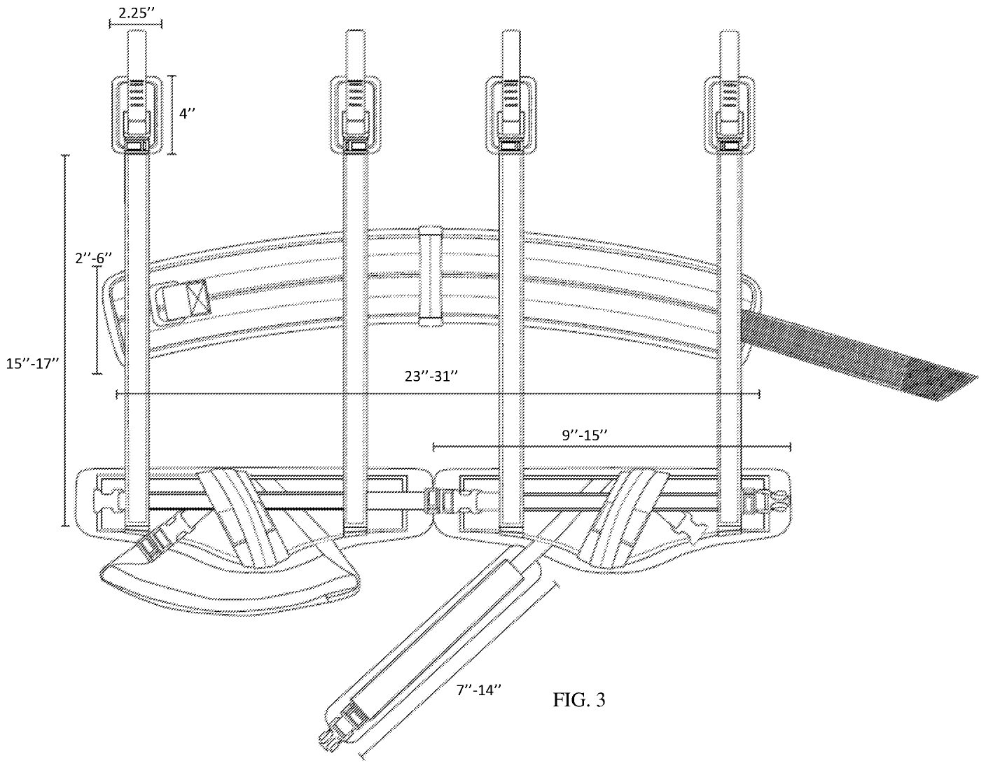

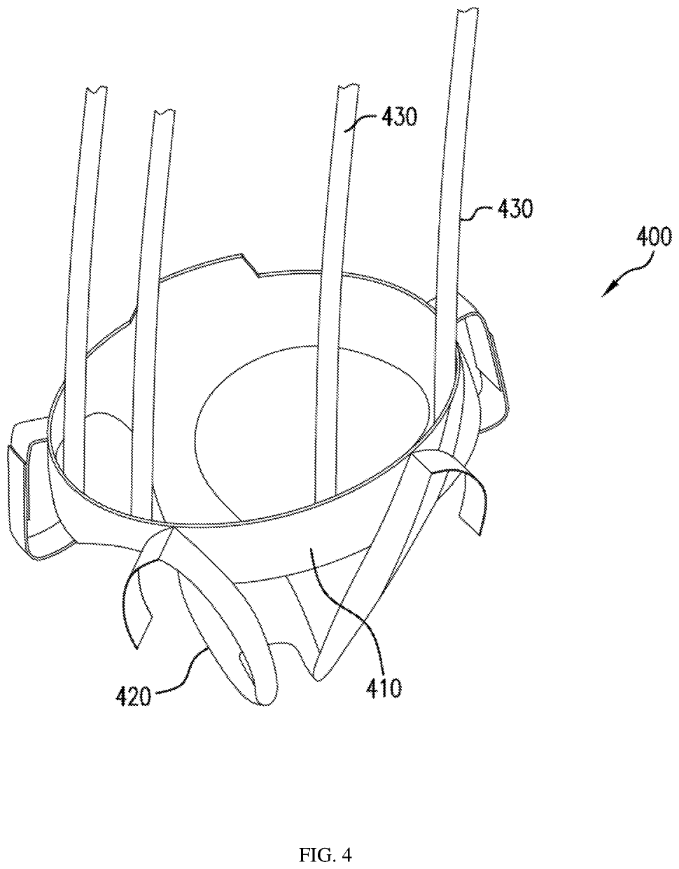

FIG. 3 provides further exemplary dimensions of a harness according to some embodiments of the disclosure.

In some embodiments, a harness of the disclosure is used for children age 1-12 years. In some embodiments, a harness of the disclosure is used for adolescents age 12-18 years. In some embodiments, a harness of the disclosure is used for adults age 18 or older.

In some embodiments, a harness of the disclosure is worn by the subject and interfaces with a “hanger” on a body weight support system to suspend and provide partial support to the subject. The harness system may accommodate variations in size/weight of children, adolescents, or adults, the sizes and shapes of the torso as the subject develops, and may also allow for progression. “Progression” refers to the improvements in control of the trunk, legs, and arms across therapy sessions. The harness is thus a dynamic component that works in synergy with the scientific principles guiding locomotor training. Support may be varied depending upon the subject's physical capacity and needs relative and specific to postural control.

In some embodiments, a harness of the disclosure is modified to accommodate the size of the patient, e.g. different dimensions relative to females (e.g. breasts) vs. males (e.g. abdominal extension). As shown in FIGS. 10-11, the harness may have a four-point overhead “suspender” design and a pelvic band for use with walking training over ground.

In some embodiments, the harness is used directly with a body weight support/treadmill unit. In other embodiments, the harness is used with devices “off” the treadmill, such as a reverse walker with an overhead support. The harness may also be used in the home to provide support and safety to a child while standing and playing with over head support systems.

A harness comprising circumferential bands within vertical strap supports allows the flexibility to meet a subject's specific trunk control needs. The bands may be easily removed and added according to the degree of trunk control capacity. This addresses the need for a device to promote therapeutic progress in trunk control and thus becomes a dynamic harness (allowing for change in a subject's capacity and abilities) as opposed to a static harness (without such capacity for change). A reduction in the weight of the harness, static contact points between the harness and the patient, and the adaptability in level of trunk support provided adds to the harness' therapeutic value.

While the present application has been particularly shown and described with respect to various embodiments thereof, it will be understood by those skilled in the art that the foregoing and other changes in forms and details may be made without departing from the spirit and scope of the present application. It is therefore intended that the present application not be limited to the exact forms and details described and illustrated, but fall within the scope of the appended claims.

What is claimed is:

1. A harness used for a locomotor training of a patient, comprising:
a bottom strap for providing pelvic support to the patient;
a pelvic band for providing waist support to the patient, wherein the bottom strap is releasably connected to the pelvic band; and
a plurality of lifting straps connected to the pelvic band, wherein the plurality of lifting straps are manipulatable to provide partial weight support to the patient.

2. The harness of claim 1, further comprising a plurality of handles provided to the pelvic band, for allowing a trainer of the locomotor training to guide the hips of the patient into the harness.

3. The harness of claim 1, wherein the bottom strap comprises at least one leg strap having a front end and a rear end, the rear end fixed to the pelvic band and the front end releasably connected to the pelvic band through a buckle, and wherein the front end of the bottom strap is adjustable to tighten the bottom strap.

4. The harness of claim 3, wherein the bottom strap further comprises a soft padding releasably wrapped around the at least one leg strap.

5. The harness of claim 1, wherein the pelvic band comprises a first end and a second end connected to each other through a middle buckle, wherein the distance between the first end and the second end of the pelvic band is adjustable to tighten the pelvic band.

6. The harness of claim 1, further comprising an upper body support system for guiding the upper torso of the patient during the locomotor training.

7. The harness of claim 6, wherein the upper body support system comprises:
an adjustable upper trunk support above the pelvic band, for maintaining the upper trunk the patient in a correct posture during the locomotor training.

8. The harness of claim 7, further comprising a plurality of strap holders connected to the adjustable upper trunk support, wherein a respective lifting strap passes through a respective strap holder.

9. The harness of claim 6, wherein the upper body support system comprises:
an adjustable shoulder strap for maintaining the shoulders of the patient in a correct posture during the locomotor training;
an adjustable upper trunk support below the shoulder strap, for maintaining the upper trunk the patient in a correct posture during the locomotor training; and
a front piece below the adjustable upper trunk support and between two front lifting straps.

10. The harness of claim 1, wherein the pelvic band is in the form of a belt and the length of the pelvic band is adjustable laterally.

11. The harness of claim 1, further comprising a plurality of strap holders connected to the pelvic band, wherein a respective lifting strap passes through a respective strap holder and the bottom strap.

12. The harness of claim 1, wherein the bottom strap and the pelvic band are formed as one piece.

13. A method for locomotor training of a patient and, comprising attaching the harness of claim 1 to the patient, wherein the harness provides support during standing and stepping activities.
